(19) United States
(12) Patent Application Publication
(10) Pub. No.: US 2010/0055928 A1
(43) Pub. Date: Mar. 4, 2010

(54) CONNECTOR FOR PROVIDING POWER TO A MOBILE ELECTRONIC DEVICE

(76) Inventor: Mitch Randall, Boulder, CO (US)

Correspondence Address: COCHRAN FREUND & YOUNG LLC, 2026 CARIBOU DR, SUITE 201, FORT COLLINS, CO, 80525, US

(21) Appl. No.: 12/509,421

(22) Filed: Jul. 24, 2009

Related U.S. Application Data
(60) Provisional application No. 61/083,475, filed on Jul. 24, 2008.

(51) Int. Cl. H01R 12/00; H01R 13/58; H01R 13/60

(52) U.S. Cl. 439/1; 439/466; 439/534

(57) ABSTRACT

It is sometimes advantageous to provide power to the mobile electronic device while using the mobile electronic device. The present connector transfers power from a power source to the mobile electronic device via an element module, a cable, and a plug of the connector. The connector enables the user to: a) interface the element module with the mobile electronic device; and, b) interface the plug with a power source (wall transformer, automobile power jack, aircraft power jack, etc.).

### CROSS-REFERENCES TO RELATED APPLICATIONS

This application is a non-provisional application based upon and claims priority to U.S. provisional application Ser. No. 61/083,475 filed Jul. 24, 2008, entitled “APPARATUS FOR ALLOWING FREEDOM OF MOTION FOR DEVICES OUTFITTED FOR AND RECEIVING WIRELESS POWER,” which is specifically incorporated herein by reference for all that it discloses and teaches.

### BACKGROUND OF THE INVENTION

1. Field of the Invention

The present invention relates generally to connectors for providing power to mobile electronic devices.

2. Description of the Prior Art

A variety of electronic or electrically powered devices, including portable and/or hand-held devices, such as cell phones, cameras, personal digital assistants, recorders, tools, razors, toys, and game devices have been developed along with ways for powering them. Many of such mobile and/or hand-held electronic devices (herein sometimes called just mobile electronic devices for convenience) typically include, and are powered by, batteries. The batteries are often rechargeable by connecting the mobile or hand-held electronic device to a power source with a connector. Connectors may include transformers and/or power converters to condition the power supplied to the mobile electronic device. Typical power sources include, but are not limited to, an electric wall outlet, a connection to the power grid, and/or an automobile accessory electric outlet or the like. Most manufacturers of mobile and/or electronic devices provide power converters or transformers with wire connectors that are unique to their devices, but there are some recent power delivery and receiver devices comprising power delivery pads or surfaces on which such mobile or hand-held devices can be positioned in virtually any orientation to receive power through conductive contacts or inductively for recharging batteries.

Example universal power receiver adapters are described in, for example, U.S. Pat. No. 7,172,196, issued on Feb. 6, 2007, and U.S. Patent Application Ser. No. 61/033,229 filed Mar. 3, 2009, entitled “APPARATUS FOR RETROFITTING A BROAD RANGE OF MOBILE DEVICES TO RECEIVE WIRELESS POWER”, both of which are incorporated herein by reference for all that they disclose and teach. The foregoing examples of related art and limitations related therewith are intended to be illustrative and not exclusive, and they do not imply any limitations on the inventions described herein. Other limitations of the related art will become apparent to those skilled in the art upon a reading of the specification and a study of the drawings.

### BRIEF DESCRIPTION OF THE DRAWINGS

The accompanying drawings, which are incorporated herein and form a part of the specification, illustrate some, but not the only or exclusive, example embodiments and/or features. It is intended that the embodiments and figures disclosed herein are to be considered illustrative rather than limiting.

In the Drawings:

FIG. 1A is a perspective view of an example of a power system having a base unit and a portable power pad that may be used instead of the base unit;

FIG. 1B is a perspective rear view of an example of a portable power pad for providing power to an example of a mobile electronic device;

FIG. 2 is a perspective rear view of the portable power pad of FIG. 1B interfaced with the mobile electronic device of FIG. 1B;

FIG. 3 is a top plan view of the portable power pad of FIG. 1B;

FIG. 4 is a top plan view of the mobile electronic device of FIG. 1B;

FIG. 5 is a perspective view of a example of a portable power pad interfaced with an example of a mobile electronic device illustrated by phantom lines;

FIG. 6 is a back elevation view of the portable power pad and mobile electronic device of FIG. 5;

FIG. 7 is a left side elevation view of the portable power pad of FIG. 5;

FIG. 8 is a front plan view of the portable power pad of FIG. 5;

FIG. 9 is a right side elevation view of the portable power pad of FIG. 5;

FIG. 10 is a top plan view of the portable power pad of FIG. 5;

FIG. 11 is a bottom plan view of the portable power pad of FIG. 5; and

FIG. 12 shows a mobile electronic device and portable power pad with inductive coils.

### DETAILED DESCRIPTION OF THE PREFERRED EMBODIMENTS

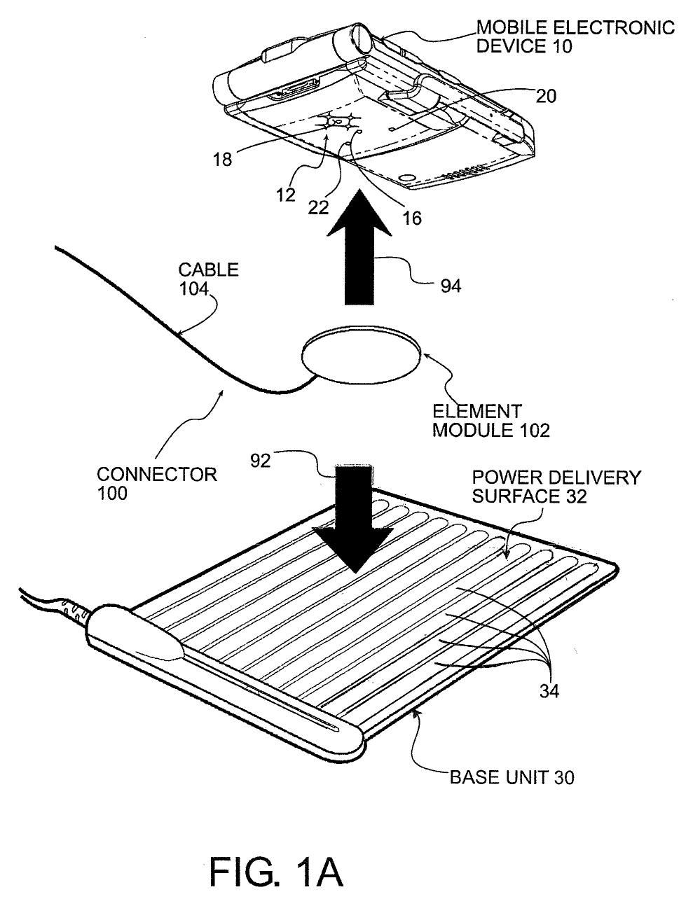

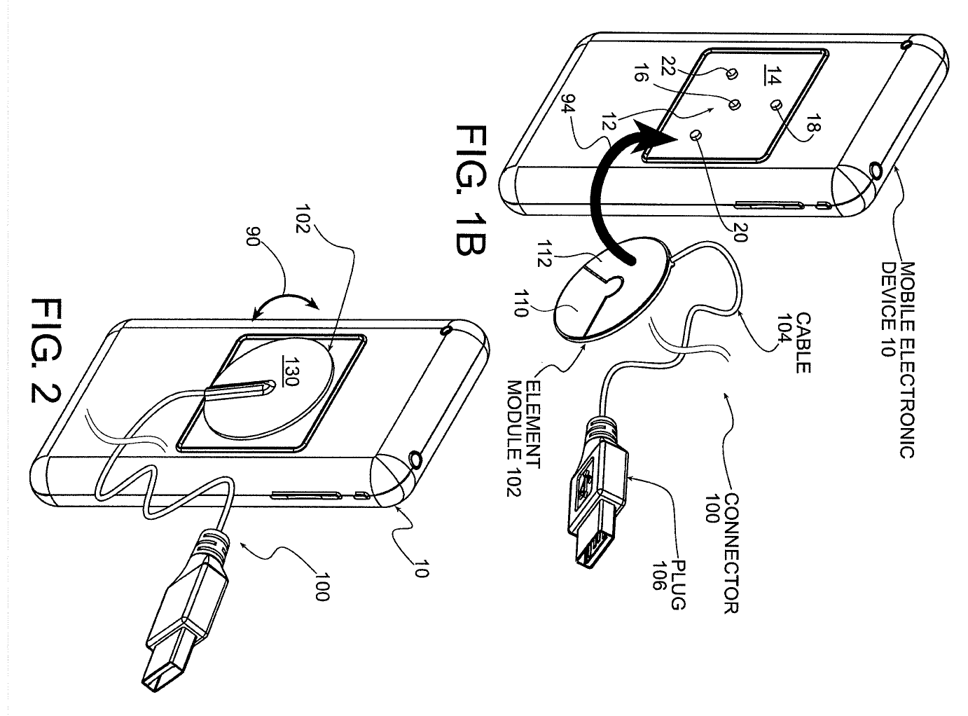

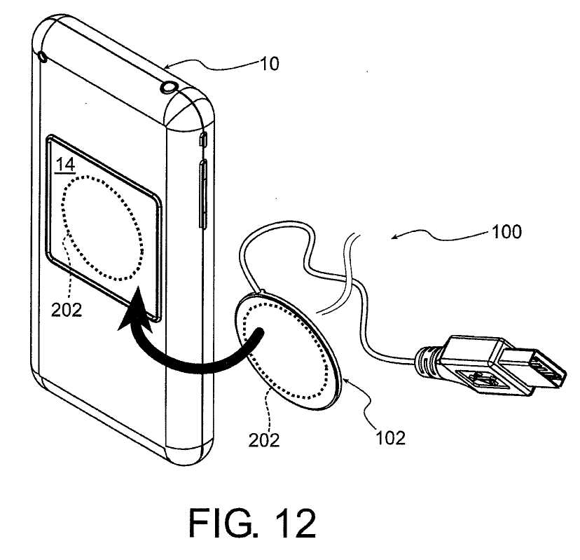

An example mobile electronic device 10 configured with one example of an input or receiver power receptacle 12 located on a back 14 or other surface of the mobile electronic device 10 is shown in FIG. 1A. In one example embodiment, the input power receptacle 12 includes a first contact 16, a second contact 18, a third contact 20 and a fourth contact 22. The first contact 16 is centrally located on the back 14 or other surface and the second, third and fourth contacts 18, 20, 22 are equally spaced around, and concentric to, the first contact 16. In general terms, the mobile electronic device 10 can be placed as illustrated by arrow 92 onto a base unit or power pad 30 for wirelessly powering or recharging the mobile electronic device 10. The base unit or power pad 30 has a power delivery surface 32 that houses either conductive (as shown in FIG. 1A) or inductive, as shown in FIG. 12, power transmission from the base unit 30 to the mobile electronic device 10. Both technologies, conductive and inductive, require close proximity of the mobile electronic device 10 to the base unit power delivery surface 32. In some cases, the power delivery surface 32 has interspersed conductor strips or pads 34, and in other cases inductive coupling coils of wire 200, 202 (FIG. 12) lie just beneath a protective surface. The base unit or power pad 30 may be bulky and/or inconvenient to move and therefore, the base units or power pads 30 usually remain essentially stationary upon a surface such as a counter, dashboard, or desktop, until such time they are transported to another location. Situations may arise when it is desirable for the mobile electronic device 10 that is equipped with contacts or inductive coils configured to receive power wirelessly by being positioned on a power pad or base unit 10 to alternately receive power while it is being used in a manner that is not conducive to sitting on the power pad or base unit 10. Such a case may be when a battery (not shown) in the device 10 is low or exhausted and the user wishes to use the mobile electronic device 10 in a way that requires it being held apart from the essentially fixed power pad or base unit 30. Therefore, the example alternate connector or portable power pad 100 can be used in place of the fixed base unit 30 to deliver power to the input power receptacle 12, as indicated by arrow 94.

With reference to FIG. 1B, to recharge the mobile electronic device 10, the connector or portable power pad 100 includes an element module 102, a cable 104, and some kind of plug or other connector 106. In general terms, the user can: a) interface the element module 102 of the portable power pad 100 with the input power receptacle 12, on the mobile electronic device 10, as indicated by arrow 94; and, b) interface the plug 106 or other connector with a power source (wall transformer, auxiliary power jack on a computer, automobile, aircraft, etc., not shown).

FIG. 2 is a perspective rear view of the portable power pad 100 interfaced with the mobile electronic device 10 so that power can flow from a power source to which the plug 106 or other connector can be connected (not shown) to the mobile electronic device 10 via the portable power pad 100. The element module 102 can be positioned at any angular orientation as indicated by arrow 90, and with some lateral tolerance, and still achieve transfer of power from the portable power pad 100 to the mobile electronic device 10. Therefore, a user may use the mobile electronic device 10 and move it around while it is being charged with the mobile electronic device 10.

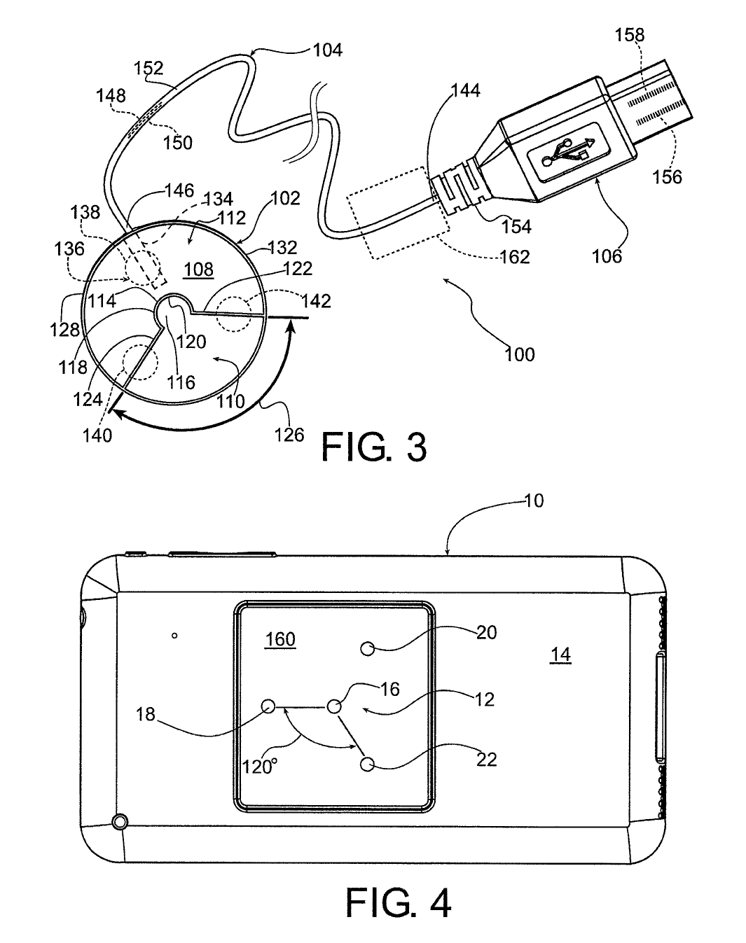

FIG. 3 is a top plan view of the connector or portable power pad 100. The connector example portable power pad 100 includes the element module 102, the cable 104 and the plug 106. The element module 102 has an interface surface 108 with at least a first electrode 110 and a second electrode 112 positioned thereon. The electrodes 110, 112 are electrically conductive and substantially resistant to corrosions, e.g. nickel plated brass; furthermore, the electrodes 110, 112 may be manufactured by photo-resist etching of an electronics board substrate covered in conductive metal such as copper. In one example embodiment, the two electrodes 110, 112 are: flat; coplanar; substantially cover the interface surface 108; and, are electrically separated, for example, by an insulator 114. The first electrode 110 and second electrode 112 include separate areas of a circle. The first electrode 110 includes an arc of less than 180 degrees and may include a hub portion 116 located at the center of the element module 102 that extends through the center of the circle. It can include a sector of the circle. The second electrode 112 includes an arc of more than 180 degrees and may be formed with a recess 118 that is concentric to the hub portion 116 of the first electrode 110. A center boundary 120 of the insulator 114 separates the first electrode center or hub portion 116 from the second electrode 112. The insulator 114 may further include a first spoke 122 and a second spoke 124 that radiate outward from the center of the element module 102 between the first and second electrodes 110, 112. In one example embodiment, the spokes 122, 124 are transverse and form an angle of intersection 126 less than 180 degrees, for example, between 100 and 140 degrees, and it may be about 120 degrees. The first and second electrodes 110, 112, respectively, accommodate power transfer to the device 10 via the contacts 16, 18, 20, 22 regardless of the angular orientation of the portable power pad 100 with respect to the input power receptacle 12. Also, they accommodate some lateral placement tolerance, for example, but not for limitation, the center contact 16 contacting anyplace on the hub portion 116.

With continued reference to FIG. 3, the element module 102 may be provided with a cover 128 that covers a back surface 130 (see, FIG. 2); additionally, the cover 128 forms an outermost perimeter 132 of the element module 102. The element module 102 may be provided with a cable grommet 134 formed in the back surface 130 for receiving the cable 104 and for stress relief on the wires 148, 150. The element module 102 is also provided with an attachment system 136. Although attachment system 136 may include a variety of mechanisms, one example of the attachment system 136 operates with at least a first magnet 138. The attachment system 136 may include additional magnets such as the illustrated second and third magnets 140, 142, respectively. These attachment system magnets 138, 140, 142 are strong and small enough to be hidden inside the element module 102 between the interface surface 108 and the cover 128 and, when attracted to a magnetic material in the input power receptacle 12, function to hold the portable power pad 100 on the input power receptacle 12 in contact with the contacts 16, 18, 20, 22.

With continued reference to FIG. 3, the cable 104 may be a multi-conductor cable capable of carrying signals between a first end 144 and a second end 146. The cable 104 includes at least a first wire 148 and a second wire 150 housed in a cover or sheath 152. The cable second end 146 engages the element module 102 at the cable grommet 134. The cable first wire 148 is electrically interfaced, therefore attached, to the first electrode 110 by any of a variety of known attachment methods such as, for example, soldered. The cable second wire 150 is attached, e.g. by solder, to the second electrode 112. Attachment of the cable 104 to the element module 102 allows the wires 148, 150 to be electrically interfaced with the electrodes 110, 112, respectively. It should be noted that the cable 104 may include additional wires for other purposes as required. The previously-mentioned plug 106 may be any of a variety of plugs used for electronic devices such as, for example, a universal serial bus ‘USB’ plug as illustrated. The plug 106 includes a cable grommet 154, a first conductor 156 and a second conductor 158. The cable 104 engages the plug 106 at the cable grommet 154. The cable first wire 148 is electrically interfaced, e.g. soldered, with the plug first conductor 156. The cable second wire 150 is electrically interfaced with the plug second conductor 158. Attachment of the cable 104 to the plug 106 allows the wires 148, 150 to be electrically interfaced with the conductors 156, 158, respectively. It can be appreciated that the plug first and second conductors 156, 158 are electrically interfaced with the element module first and second electrodes 112, 114, respectively.

With reference to FIG. 4 illustrating the mobile electronic device 10 provided with the input power receptacle 12 (including the connectors 16, 18, 20, 22), the first connector 16 is centrally located on the mobile electronic device back 14 and the second, third and fourth connectors 18, 20, 22 are equally spaced around, and concentric to, the first connector 16. In one embodiment, connectors 18, 20, 22 are equally spaced 120 degrees apart. The connectors 16, 18, 20, 22 are usually flush or slightly protruding (optionally spring-loaded) from the back 14 or input power receptacle 12 of the mobile electronic device 10 and can be contacted with either the base unit power pad 30 or the connector element module 102. One example of the input power receptacle 12 is described in U.S. Patent Application Ser. No. 61/033,229 filed Mar. 3, 2009, entitled “APPARATUS FOR RETROFITTING A BROAD RANGE OF MOBILE DEVICES TO RECEIVE WIRELESS POWER,” which is specifically incorporated herein by reference for all that it discloses and teaches. In one embodiment, the back 14 of the mobile electronic device 10 is provided with components of the attachment system 136. One type attachment system 136 (see, FIG. 3) incorporates an iron-bearing or other magnetic material 160, such as a plate of steel, that attracts the element module magnets 138, 140, 142 (see, FIG. 3). In other words, the back 14 has a steel plate or other magnetic material at or near the surface that attracts magnets (e.g. magnets 138, 140, 142). Mobile electrical device 10 may be for example, but not for limitation, a cellular phone; a media player; an audio device; a video device; a gaming device; a calculator; a timepiece; tool, or the like.

Having described examples of components of the present embodiment, utilization of the connector 100 for powering the mobile electronic device 10 will be presented. With reference again to FIG. 3, the element module first electrode hub portion 116 may be located at the center of the element module 102 on the mobile electrical device 10; positioning the element module 102 causes the first electrode 110 (see, FIG. 3) to electrically interface the input power receptacle second connector 16 (see, FIG. 4). In a similar manner, the second electrode 112 electrically interfaces at least one, but usually two, of the input power receptacle contacts 18, 20, 22. Electronics (such as a four-way bridge rectifier described in U.S. Pat. No. 7,172,196, issued on Feb. 6, 2007, or in U.S. patent application Ser. No. 12/380,893 filed Mar. 3, 2009, entitled “UNIVERSAL ELECTRICAL INTERFACE FOR PROVIDING POWER TO MOBILE DEVICES,” which are specifically incorporated herein by reference for all that they disclose and teach) properly route the electric power from contacts 16, 18, 20 of the input power receptacle 12 into the device 10 (including any conditioning circuits, etc. One skilled in the art will recognize that a variety of rectifier circuits and other control circuitry may be utilized to ensure proper electrical power connection of the contacts 14, 16, 18, 20. In the end, a voltage potential between the first electrode 110 and the second electrode 112 is presented to the mobile electronic device 10 via the input power receptacle 12 when the attachment system 136 urges the element module 102 towards the mobile electronic device 10. The voltage potential at the electrodes 110, 112 is presented from the plug conductors 156, 158 via the cable wires 148, 150. The above-referenced ‘positioning’ of the element module 102 may be assisted by magnetic attraction of the element module magnets 138, 140, 142 to the iron-bearing surface 160. The same magnetic attraction may also hold the connector element module 102 against the mobile electronic device 10 to complete electrical connection between the plug 106 and the mobile electronic device 10. With the connector 100 positioned, the plug 106 can be connected to the power source, e.g. a USB port, an electrical wall outlet, car charge port, etc., to transfer power to the mobile electronic device 10. The utilization above improves usability of the mobile electronic device 100 while requiring power delivery via the connector 100.

In one alternative embodiment, the mobile electronic device 100 may require power provided thereto to be conditioned with a power driver 162 (see, FIG. 3). One type of conditioning may, for example, be tight-tolerance direct current power. As such, the power driver 162 may include a safety monitoring subsystem, waveform generator subsystem, power conversion subsystem or other necessary functions as required. If provided, this power driver 162 may be positioned anywhere in the cable 100, such as between the plug 106 and the cable first end 144.

In another alternative embodiment, the attachment system 136 may be a mechanical system. Examples of mechanical systems include, but are not limited to snaps, levers, clamps, catches, friction fits, detents or the like (not shown).

In another alternative embodiment, the attachment system 136 may include the iron-bearing or other magnetic material 160 configured in a three-legged Y-shaped pattern to cause the magnets 138, 140, 142 to register at known locations relative to the mobile electronic device 10.

In another alternative embodiment, the input power receptacle 12 and electrical components of the element module 102 (e.g. first electrode 110 and second electrode 112) may be replaced by a transmission system that operates on contactless transmission of power, such as induction, as shown in FIG. 12. Accordingly, the input power receptacle 12 may include a receiver coil 202 while the connector element module 102 includes a transmitter coil 200 and components for transmitting power inductively to the coil of wire. Such inductive coupling or power transmission is described in the U.S. patent application Ser. No. 12/348,881, filed on Jan. 5, 2009, which is incorporated herein by reference for all that it discloses and teaches. Since either conductive or inductive wireless power receiver hardware can both equally well and readily fit within the volume provided by the present embodiment, it is obvious to one skilled in the art that either power reception technology could be readily interchanged within the scope and spirit of the present invention.

In another alternative embodiment, the power driver 162 may include circuitry for increasing low-voltage DC power to higher-voltage DC power. For example, USB hubs provide 5 volts while some wireless power transmitters and/or receivers operate at 15 volts. Therefore, the 5 volts may need to be stepped-up to 15 volts.

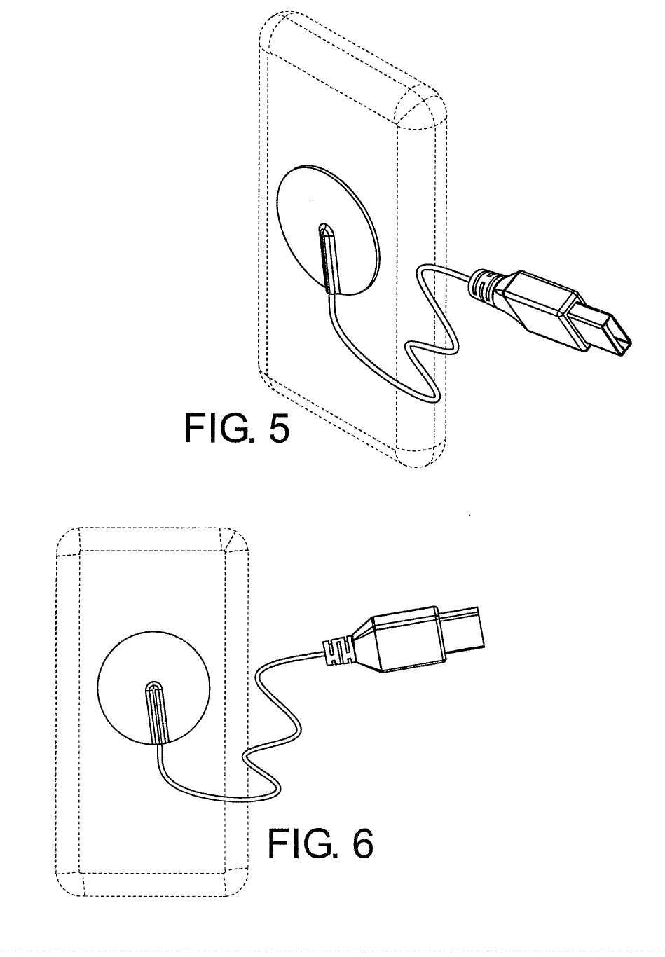

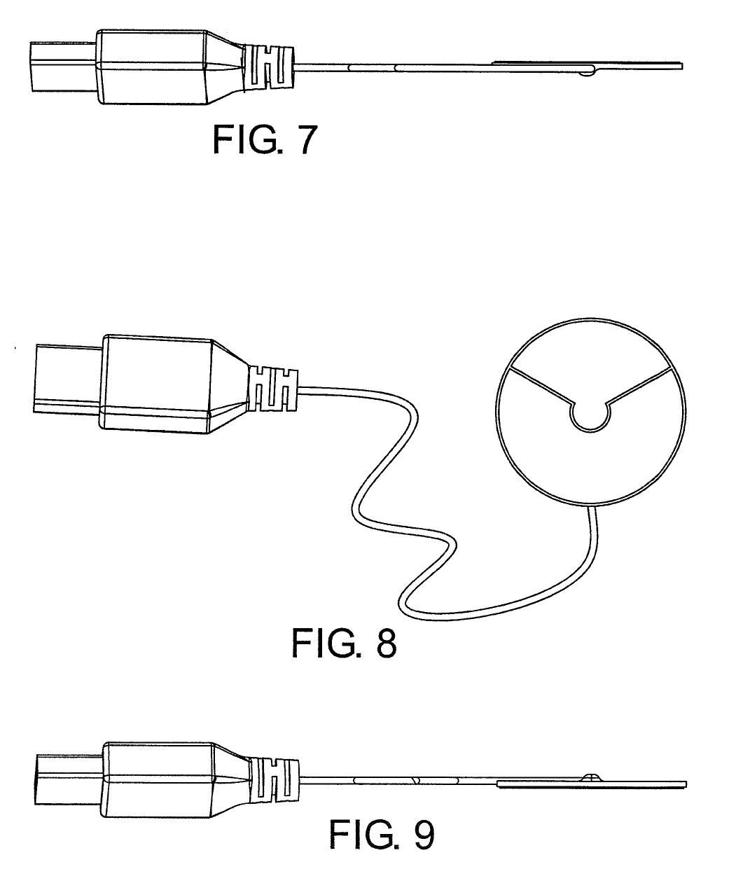

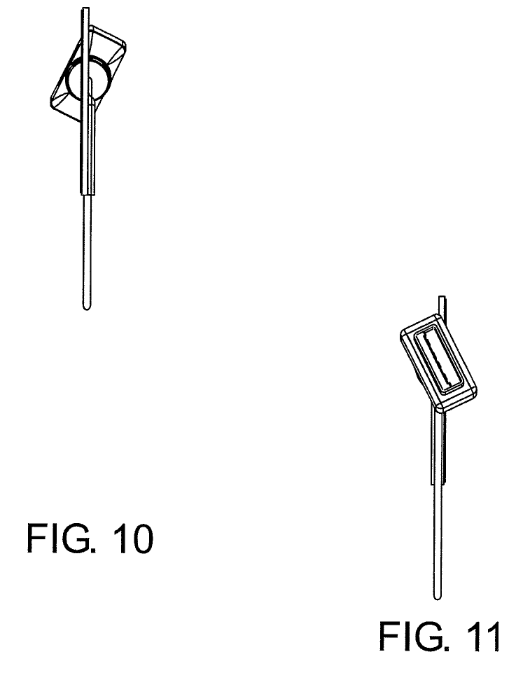

The details, components, and structures described above are examples of implementations of the invention, but other structures and components could also be used to implement the invention, which comprises a connector for providing power to a mobile electronic device. Other features of the invention can be discerned from the description above and the accompanying drawings in FIGS. 1-11, which for a part of this description.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. A portable power pad for electrically coupling a mobile electronic device, comprising a first contact and a second contact, to a power source, said connector comprising:
an element module, defining an interface surface and a center, comprising: a first electrode, formed on said interface surface, comprising: a hub located at said element module center; and a second electrode, formed on said interface surface and defining a voltage potential between said electrodes when operating, comprising: a recess, located at said element module center, that is concentric to said first electrode hub; and, an attachment system urging said element module towards said mobile electronic device such that said first electrode interfaces said first contact and said second electrode interfaces said second contact;
a cable attached to said element module comprising: a first wire attached to said first electrode; and, a second wire attached to said second electrode;
a plug, attached to said cable, comprising: a first conductor electrically interfaced with said element module first electrode with said first wire; and, a second conductor electrically interfaced with said element module second electrode with said second wire; and,
wherein said element module electrodes electrically interface with said mobile electronic module surface contacts such that power at said voltage potential is transferred from said plug to said mobile electronic device.

2. The portable power pad of claim 1 and further comprising:
an insulating first spoke radiating from said element module center towards a outermost perimeter of said element module; and,
an insulating second spoke radiating from said element module center towards said element module outermost perimeter, such that said spokes electrically insulate said first electrode from said second electrode.

3. The portable power pad of claim 2 wherein said spokes are transverse.

4. The portable power pad of claim 3 wherein said angle of intersection between 100 and 140 degrees.

5. The portable power pad of claim 4 wherein said spokes form and angle of intersection is 120 degrees.

6. The portable power pad of claim 1 wherein said plug is a universal serial bus plug.

7. The portable power pad of claim 1 and further comprising a power driver between said plug and said element module such that said element module voltage potential is created by said power driver.

8. The portable power pad of claim 1 wherein said attachment system comprises a magnet.

9. The portable power pad of claim 8 wherein said magnet is located in said element module attachment system.

10. The portable power pad of claim 9 and further comprising a total of three magnets located in said element module attachment system, said three magnets equally spaced 120 degrees apart.

11. The portable power pad of claim 1 wherein said mobile electronic device is selected from a list consisting of: a cellular phone; a camera, a personal digital assistant, a recorder, a tool, a razor, a toy, a media player; an audio device; a video device; a gaming device; a calculator; a timepiece.

12. The portable power pad of claim 1 wherein said electrodes are flat.

13. The portable power pad of claim 12 wherein said electrodes are coplanar.

14. A method of connecting a mobile electronic device, comprising a first contact and a second contact, to a power source comprising:
providing a portable power pad comprising:
an element module, defining an interface surface and a center, comprising:
a first electrode, formed on said interface surface, comprising: a hub located at said element module center; and a second electrode, formed on said interface surface and defining a voltage potential between said electrodes when operating, comprising: a recess, located at said element module center, that is concentric to said first electrode hub; and, an attachment system urging said element module towards said mobile electronic device such that said first electrode interfaces said first contact and said second electrode interfaces said second contact; and,
a cable attached to said element module comprising: a first wire attached to said first electrode; and, a second wire attached to said second electrode;
a plug, attached to said cable, comprising: a first conductor electrically interfaced with said element module first electrode with said first wire; and, a second conductor electrically interfaced with said element module second electrode with said second wire;
positioning said connector element module near said mobile electronic device contacts;
attracting said connector element module into contact with the mobile electronic device contacts with said attachment system;
holding said connector element module adjoining said mobile electronic device contacts with said attachment system; and,
connecting said plug to said power source such that said voltage potential is transferred to said mobile electronic device through said plug, said cable, said electrodes and said mobile electronic device contacts.

15. The method of claim 14 wherein said providing said connector element module attachment system further comprises providing a magnet; and,
said attracting and said holding utilize said magnet.

16. A portable power pad for providing electric power to a mobile electrically powered device that is equipped with an input power receptacle that can receive electric power by placement at any orientation on a power delivery surface, comprising:
a portable power delivery surface sized smaller than the electrically powered device for mating with and delivering electric power to the input power receptacle;
releasable attachment means for attaching the portable power delivery surface to the input power receptacle;
flexible wire means for transmitting power from an electric power source to the portable power delivery surface; and
power conditioning means for conditioning power from the electric power source to a condition that is receivable by the mobile electrically powered device.

17. The portable power pad of claim 16, including inductive power delivery means adjacent the portable power delivery surface.

18. The portable power pad of claim 17, wherein the inductive power delivery means includes a transmitter coil.

19. The portable power pad of claim 18, including inductive power drive means for driving the transmitter coil to transmit an alternating magnetic field that is receivable by a receiver coil in the input power receptacle for generating electric current in the input power receptacle.

20. The portable power pad of claim 16, including surface electrode means as part of the portable power delivery surface for delivering electric power to power receiver contacts that are part of the input power receptacle.

21. The portable power pad of claim 20, wherein the surface electrode means includes at least two flat surface electrodes separated electrically from each other and positioned in co-planar relation to each other and connectable to opposite polarities of the power source, wherein said flat surface electrodes are sized and shaped in a manner that is capable of connecting opposite polarities of the power to at least two of the contacts of the input power receptacle regardless of angular orientation of the portable power delivery surface in relation to the input power receptacle.

22. The portable power pad of claim 21, wherein the two flat surface electrodes together include a circle and each of which provides an arc of the circle, and one of which extends in a hub portion through the center of the circle.

23. The portable power pad of claim 22, wherein the arc included by one of the electrodes includes less than 180 degrees of the circle and the arc included by the other of the electrodes includes more than 180 degrees.

24. The portable power pad of claim 23, wherein the electrode that includes an arc of less than 180 degrees of the circle has the hub portion.

25. The portable power pad of claim 24, wherein the electrode that has the hub portion includes a sector of the circle.

26. The portable power pad of claim 24, wherein the arc included by the electrode that has the hub portion is about 100 to 140 degrees.

27. The portable power pad of claim 27, wherein the arc included by the electrode that has the hub portion is about 120 degrees.
